(19) United States
(12) Patent Application Publication
(10) Pub. No.: US 2008/0264202 A1
(43) Pub. Date: Oct. 30, 2008

(54) Hypoid gear motor and method of producing hypoid gear motor

(75) Inventor: Yasushi Mineshima, Kurashiki-shi (JP)

Correspondence Address: IPUSA, P.L.L.C, 1054 31ST STREET, N.W., Suite 400, Washington, DC, 20007, US

(73) Assignee: SUMITOMO HEAVY INDUSTRIES, LTD.

(21) Appl. No.: 12/081,437

(22) Filed: Apr. 16, 2008

(30) Foreign Application Priority Data
Apr. 27, 2007 (JP) 2007-120143

(51) Int. Cl. F16H 57/02

(52) U.S. Cl. 74/606 R

(57) ABSTRACT

A hypoid gear motor has a gear casing, first and second bearings, a motor having a motor shaft, a hypoid pinion having a penetration hole and a tooth flank on an outer periphery thereof, with the motor shaft fitted into the penetration hole, a hypoid gear shaft having a hypoid gear which meshes with the hypoid pinion, and two ends respectively supported on the gear casing via the first and second bearings, and first and second shim members arranged adjacent to the first and second bearings, respectively. The first and second shim members independently adjust a position of the hypoid gear shaft in an axial direction thereof with respect to the hypoid pinion and the gear casing.

### BACKGROUND OF THE INVENTION

1. Field of the Invention

The present invention generally relates to hypoid gear motors and methods of producing hypoid gear motors, and more particularly to a hypoid gear motor having a structure suited for a design with a high capacity and a low reduction gear ratio and to a method of producing such a hypoid gear motor.

2. Description of the Related Art

For example, a Japanese Laid-Open Patent Application No. 2001-103710 proposes a hypoid gear motor for realizing a wide range of reduction gear ratios, from a low reduction gear ratio to a high reduction gear ratio.

FIG. 1 is a cross sectional view showing an example of a conventional hypoid gear motor, namely, the hypoid gear motor proposed in the Japanese Laid-Open Patent Application No. 2001-103710. A hypoid gear motor HGM1 shown in FIG. 1 integrally has a motor M1 and a reduction gear G1.

A first gear stage of the reduction gear G1 is formed by a hypoid pinion 16 directly connected to a motor shaft 14, and a hypoid gear 20 provided on a hypoid gear shaft 18 and meshing with the hypoid pinion 16. The hypoid pinion 16 and the hypoid gear 20 realize a relatively high reduction gear ratio of approximately 1/5 to approximately 1/15.

A second gear stage of the reduction gear G1 is formed by a first intermediate pinion 24 provided on the hypoid gear shaft 18, and a first intermediate gear 28 provided on an intermediate shaft 26 and meshing with the first intermediate pinion 24.

A third gear stage of the reduction gear G1 is formed by a second intermediate pinion 32 provided on the intermediate shaft 26, and an output gear 36 provided on an output shaft 34 and meshing with the second intermediate pinion 32.

Motors having the same frame number (or capacity class) use identical casings. In other words, when replacing the motor by a motor having a different frame number with a larger capacity, the reduction gear connected to the motor is also changed to a larger reduction gear. Because the hypoid gear set is relatively expensive, the same hypoid gear set is used to realize a plurality of reduction gear ratios from a relatively low reduction gear ratio to a relatively high reduction gear ratio, and the total reduction gear ratio is changed by changing the reduction gear ratios of other gear sets.

Recently, in order to speed up production of products or goods, there are demands to realize high capacity and high-speed drive also in the fields where the hypoid gear motor is applied.

In order to realize the high capacity, a motor having a high capacity or output is basically used, in combination with a large-scale reduction gear suited for the high-capacity motor. In order to realize the high-speed drive, the reduction gear ratio is set relatively low, and the output shaft is rotated without greatly reducing the rotational speed of the motor.

When a relatively low gear ratio is realized by use of a motor having a certain capacity, an output torque of the output shaft naturally becomes small. For this reason, in order to realize a high-speed drive with the same torque of the output shaft, it is necessary to increase the capacity of the motor.

However, increasing the capacity of the motor means employing a motor having frame number (or capacity class) with a larger scale or, a motor with a higher rank in terms of the capacity in the same series of motors. Hence, the scale of a reduction gear casing and the like which are combined with the motor also becomes larger as the capacity of the motor is increased. When the scale of the reduction gear casing and the like becomes large, connecting dimensions (or mating dimensions) of the reduction gear casing and the like with respect to other machines become different. For example, if the high-speed drive were to be realized by maintaining the same torque in an existing production facility, there is a problem in that it would be necessary to make design modifications of the connecting dimensions or linkage mechanisms of the reduction gear casing and the like with respect to the production facility.

### SUMMARY OF THE INVENTION

Accordingly, it is a general object of the present invention to provide a novel and useful hypoid gear motor and method of producing hypoid gear motor, in which the problems described above are suppressed.

Another and more specific object of the present invention is to provide a hypoid gear motor having a structure suited for a design with a high capacity and a low reduction gear ratio (or a high-speed drive) while minimizing the size of the hypoid gear motor, and to a method of producing such a hypoid gear motor.

According to one aspect of the present invention, there is provided a hypoid gear motor comprising a casing; a first bearing; a second bearing; a motor having a motor shaft; a hypoid pinion having a penetration hole, and a tooth flank on an outer periphery thereof, the hypoid pinion being separate from the motor shaft and being fixed to the motor shaft which is fitted into the penetration hole; a hypoid gear shaft having a hypoid gear which meshes with the hypoid pinion, and two ends respectively supported on the casing via the first and second bearings; a first shim member arranged adjacent to the first bearing; and a second shim member arranged adjacent to the second bearing, wherein the first and second shim members independently adjust a position of the hypoid gear shaft in an axial direction thereof with respect to the hypoid pinion and the casing. In this case, it is possible to realize a hypoid gear motor having a structure suited for a design with a high capacity and a low reduction gear ratio (or a high-speed drive) while minimizing the size of the hypoid gear motor.

According to another aspect of the present invention, there is provide a hypoid gear motor comprising a gear casing; a first bearing part; a second bearing part; a motor having a motor shaft; a hypoid pinion having a penetration hole, and a tooth flank on an outer periphery thereof, the hypoid pinion being fixed to the motor shaft which is fitted into the penetration hole; a hypoid gear shaft having a hypoid gear which meshes with the hypoid pinion, and two ends respectively supported on the gear casing via the first and second bearing parts, wherein a position of the hypoid gear shaft in an axial direction thereof with respect to the hypoid pinion and the gear casing is independently adjustable by the first and second bearing parts. In this case, it is possible to realize a hypoid gear motor having a structure suited for a design with a high capacity and a low reduction gear ratio (or high-speed drive) while minimizing the size of the hypoid gear motor.

According to still another aspect of the present invention, there is provided a method of producing a hypoid gear motor, comprising the steps of fixing a motor shaft of a motor to a hypoid pinion by fitting the motor shaft into a penetration hole in the hypoid pinion; assembling a hypoid gear shaft having a hypoid gear into the hypoid gear motor while adjusting meshing positions of the hypoid gear and the hypoid pinion using a first shim member which is arranged adjacent to a first bearing supporting one end of the hypoid gear shaft; and adjusting relative positions of the hypoid gear shaft and a gear casing in an axial direction using a second shim member which is arranged adjacent to a second bearing supporting another end of the hypoid gear shaft. In this case, it is possible to realize a hypoid gear motor having a structure suited for a design with a high capacity and a low reduction gear ratio (or high-speed drive) while minimizing the size of the hypoid gear motor.

Other objects and further features of the present invention will be apparent from the following detailed description when read in conjunction with the accompanying drawings.

### BRIEF DESCRIPTION OF THE DRAWINGS

FIG. 1 is a cross sectional view showing an example of a conventional hypoid gear motor;

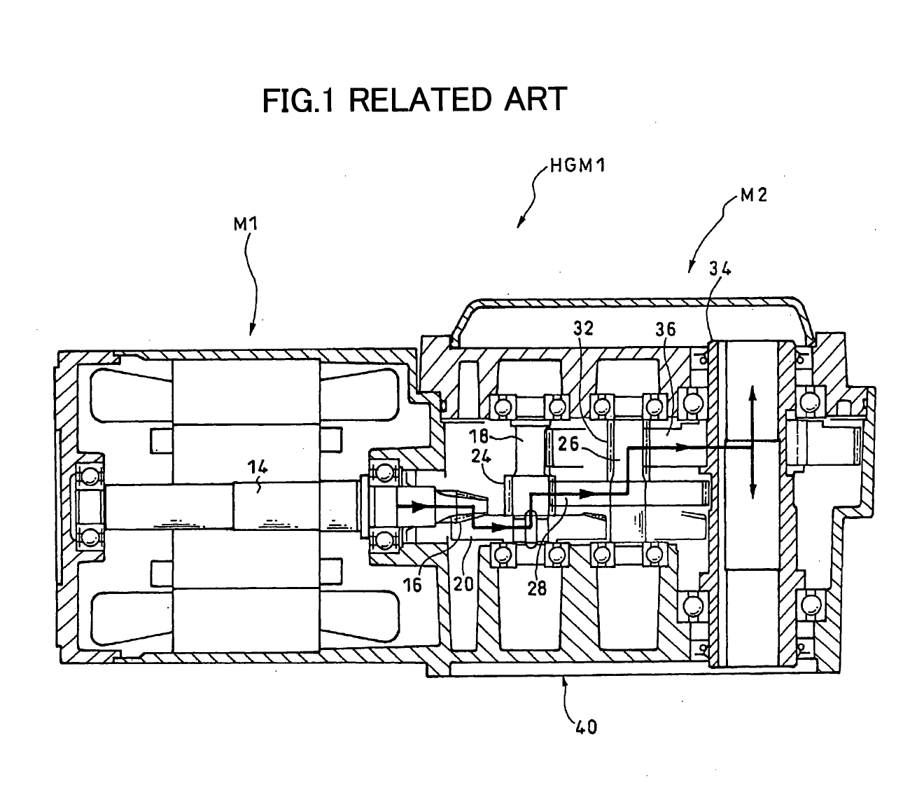

FIG. 2 is a cross sectional view showing a portion of a hypoid gear motor having a double reduction structure in one embodiment of the present invention;

FIG. 3 is a cross sectional view, on an enlarged scale, showing a portion in a vicinity of an arrow II in FIG. 2;

FIG. 4 is a cross sectional view, on an enlarged scale, showing a portion in a vicinity of an arrow III in FIG. 2;

FIG. 5 is a cross sectional view showing a portion of a hypoid gear motor having a triple reduction structure in the embodiment of the present invention;

FIG. 6 is a cross sectional view, on an enlarged scale, showing a portion in a vicinity of an arrow V in FIG. 5; and

FIG. 7 is a cross sectional view showing the entire hypoid gear motor shown in FIG. 2.

### DESCRIPTION OF THE PREFERRED EMBODIMENTS

In one embodiment of the present invention, a hypoid gear motor has a gear casing, a first bearing, a second bearing, a motor having a motor shaft, a hypoid pinion having a penetration hole and a tooth flank on an outer periphery thereof, and being separate from the motor shaft and fixed to the motor shaft which is fitted into the penetration hole, a hypoid gear shaft having a hypoid gear which meshes with the hypoid pinion and two ends respectively supported on the gear casing via the first and second bearings, a first shim member arranged adjacent to the first bearing, and a second shim member arranged adjacent to the second bearing. The first and second shim members independently adjust a position of the hypoid gear shaft in an axial direction thereof with respect to the hypoid pinion and the gear casing.

One embodiment of the present invention does not rely on the conventional concept of realizing a suitable reduction gear ratio of approximately 1/5 to approximately 1/15 by a hypoid gear set, and instead positively utilizes the hypoid gear set to realize a low reduction gear ratio. In the case of the hypoid gear set, when the outer diameters of the hypoid gears are the same, the tolerable transmission torques become approximately the same. Hence, the present inventor focused on the advantages obtainable by making the reduction gear ratio of the hypoid pinion and the hypoid gear low, namely, that it becomes possible to mount a larger motor because the tolerable transmission torques become approximately the same.

However, if the outer diameter of the hypoid gear is maintained the same and the low reduction gear ratio is to be realized, the outer diameter of the hypoid pinion inevitably becomes large. In addition, because the motor shaft itself is increased in order to increase the capacity of the hypoid gear motor, a large machine becomes necessary to produce the motor shaft with the pinion. The processing machine for producing the hypoid gear set is an extremely special machine, and is extremely expensive. For this reason, the increase in the scale of the processing machine for producing the hypoid gear set will considerably increase the production cost of the hypoid gear motor. Furthermore, it also becomes necessary to increase the scale of the facility and the like used to carry out a thermal process (or heating process) for hardening a tooth flank of the hypoid pinion. Moreover, the scale of the facility and the like used to correct deformation or the like of the motor shaft caused by the thermal process must also be increased.

On the other hand, in order to avoid these problems which newly become notable, it is conceivable to employ a technique which separately provides a so-called “hypoid pinion shaft” having a hypoid pinion on one end and a linking part on the other end to link to the motor shaft. However, this conceivable technique increase the dimensions of the hypoid gear motor in an axial direction thereof because of the provision of the hypoid pinion shaft. In addition, in order to support the hypoid pinion shaft itself and to secure accurate meshing alignment between the hypoid pinion shaft and the hypoid gear, the structure of the hypoid gear motor becomes extremely complex, and the cost of the hypoid gear motor accordingly becomes high.

Therefore, in one embodiment of the present invention, the hypoid pinion is a separate body from the motor, but the hypoid pinion is not the conventionally or generally used hypoid pinion shaft described above. This hypoid pinion has the penetration hole to which the motor shaft is fitted, and the tooth flank is provided on an outer periphery of this hypoid pinion. The motor shaft is directly fixed to this hypoid pinion via the penetration hole. Accordingly, it is possible to minimize the size of the hypoid gear motor in the radial direction thereof. In addition, the structure of the hypoid gear motor becomes simple because there is no problem associated with the support of the hypoid pinion shaft itself as in the case of the conceivable technique described above.

In one embodiment of the present invention, the first and second shim members are independent provided at two locations. The adjustment of the meshing alignment between the hypoid pinion and the hypoid gear (or hypoid gear shaft) and the positional adjustment (or positioning) of the hypoid gear shaft and the reduction gear casing are made by independently adjusting the first and second shim members to optimize the meshing alignment and the positioning. As a result, it is possible to positively and constantly maintain a highly accurate meshing alignment during operation, without having to provide a complex adjusting mechanism.

In one embodiment of the present invention, a method of producing a hypoid gear motor includes the steps of:

(a) fixing a motor shaft of a motor to a hypoid pinion by fitting the motor shaft into a penetration hole in the hypoid pinion;

(b) assembling a hypoid gear shaft having a hypoid gear into the hypoid gear motor while adjusting meshing positions of the hypoid gear and the hypoid pinion using a first shim member which is arranged adjacent to a first bearing supporting one end of the hypoid gear shaft; and

(c) adjusting relative positions of the hypoid gear shaft and a gear casing in an axial direction using a second shim member which is arranged adjacent to a second bearing supporting another end of the hypoid gear shaft.

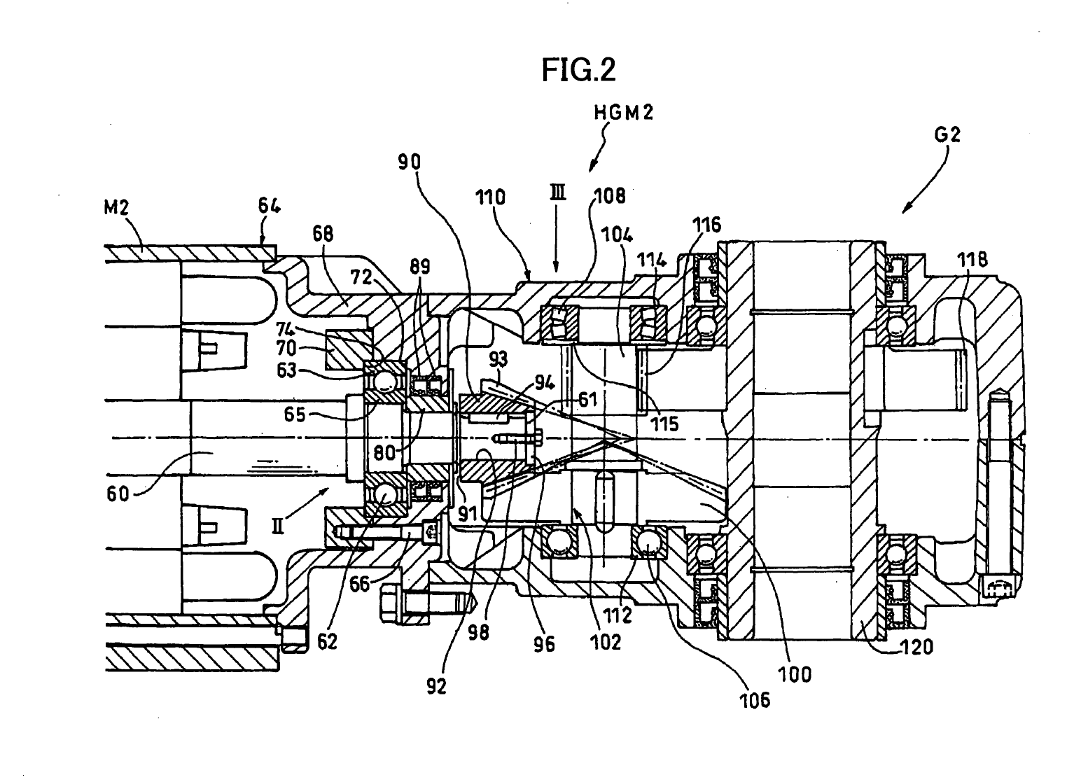

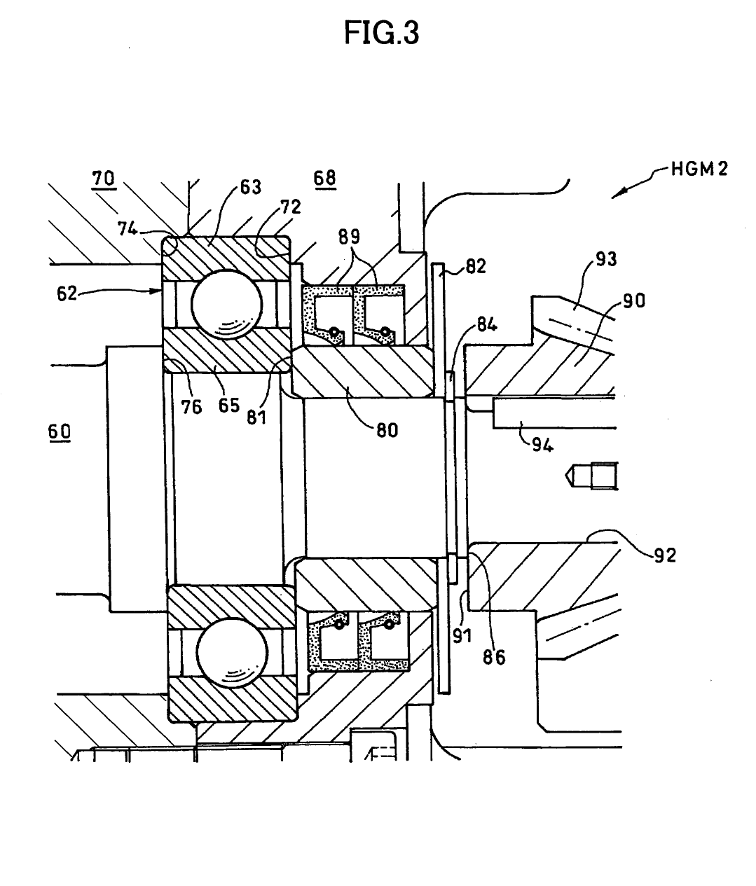

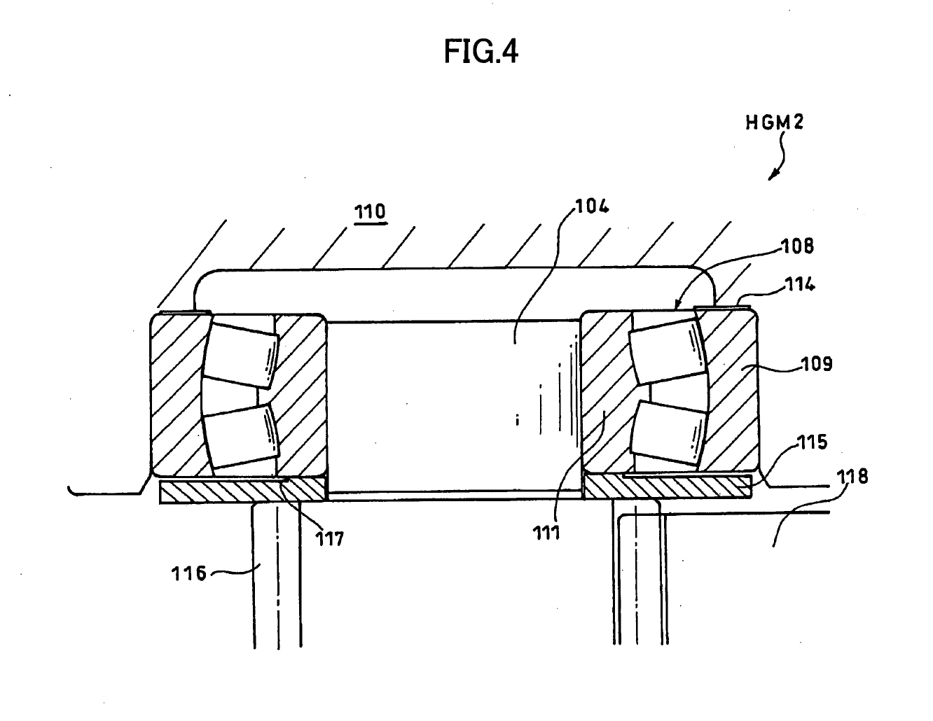

FIG. 2 is a cross sectional view showing a portion of a hypoid gear motor having a double reduction structure in one embodiment of the present invention. FIG. 3 is a cross sectional view, on an enlarged scale, showing a portion in a vicinity of an arrow II in FIG. 2, and FIG. 4 is a cross sectional view, on an enlarged scale, showing a portion in a vicinity of an arrow III in FIG. 2.

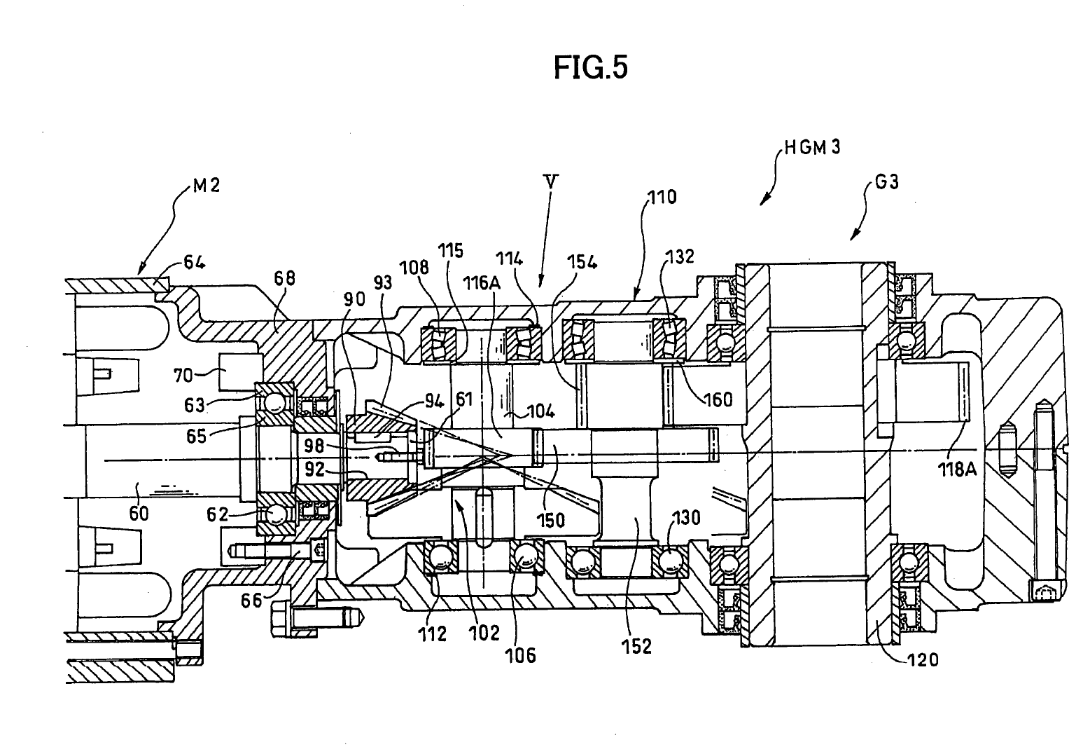

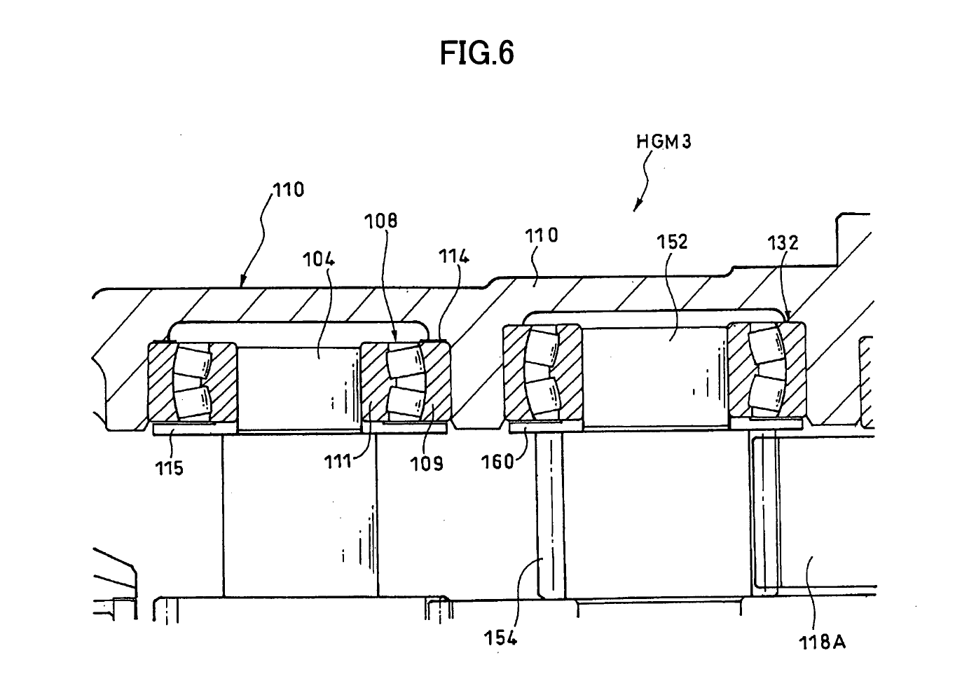

FIG. 5 is a cross sectional view showing a portion of a hypoid gear motor having a triple reduction structure in the embodiment of the present invention, using the same motor and casing as the hypoid gear motor shown in FIG. 2. FIG. 5 is a development of shafts arranged three-dimensionally in a direction perpendicular to the drawing paper, by focusing on the power transmission. Hence, a reduction gear casing 110 which will be described later actually has the same dimensions in FIGS. 2 and 5. In FIG. 5, those parts which are the same as those corresponding parts in FIG. 2 are designated by the same reference numerals, and a description thereof will be omitted. FIG. 6 is a cross sectional view, on an enlarged scale, showing a portion in a vicinity of an arrow V in FIG. 5.

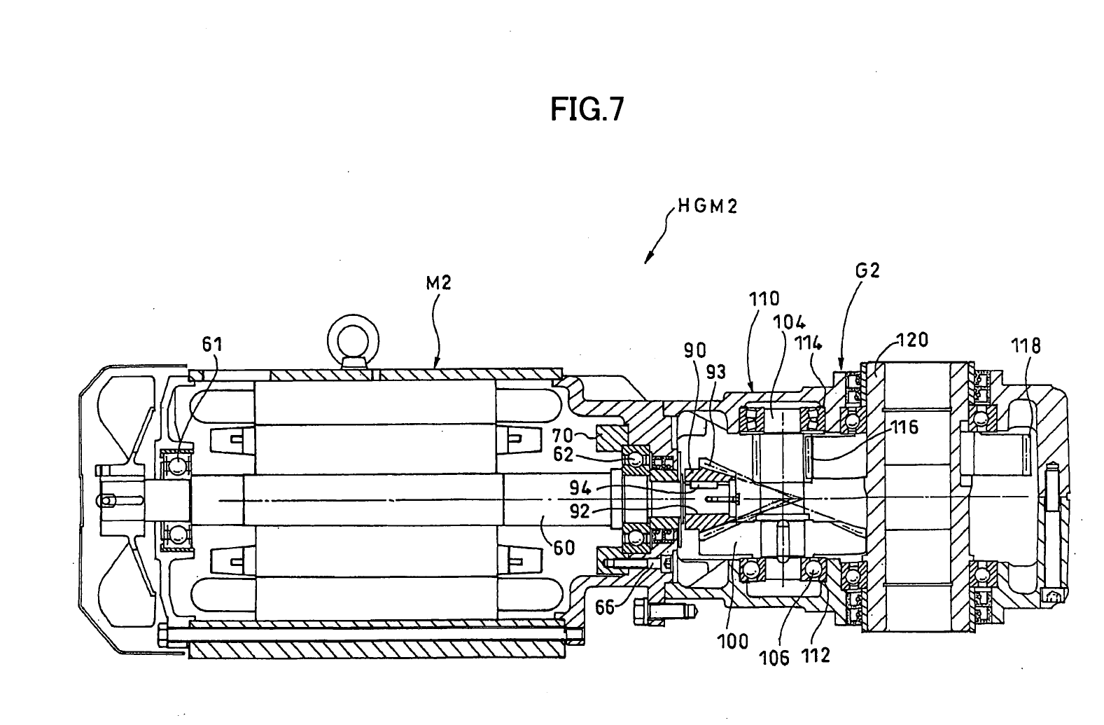

FIG. 7 is a cross sectional view showing the entire hypoid gear motor shown in FIG. 2.

As shown in FIGS. 2 and 7, a hypoid gear motor HGM2 integrally has a general-purpose motor M2 and a reduction gear G2. The motor M2 by itself is a completed motor and may be used for other purposes. A motor shaft 60 of the motor M2 is supported by a pair of ball bearings 61 and 62.

As shown in FIG. 3, of the pair of ball bearings 61 and 62, an outer ring 63 of the ball bearing 62 disposed closer to a hypoid pinion 90 than the ball bearing 61 is restricted from movement in an axial direction thereof by a stepped part 72 which is formed on a cover part 68 of a motor casing 64 and a stepped part 74 which is formed on a first ring body 70 integrally provided on the cover part 68 via a bolt 66. In addition, an inner ring 65 of the ball bearing 62 is restricted from movement in an axial direction thereof by a stepped part 76 which is formed on the motor shaft 60 and an end surface 81 of a second ring body 80 which covers the motor shaft 60. As a result, the ball bearing 62 can support loads which are applied on the motor shaft 60 in both a radial direction and a thrust direction. The second ring body 80 is securely fitted on the motor shaft 60 by interference fit and is restricted from movement towards the reduction gear G2 in the axial direction by a snap ring 84 and a stopper plate 82 for preventing grease within the reduction gear G2 from entering within the motor M2. In FIG. 3, a reference numeral 89 denotes an oil seal.

The hypoid pinion 90 is a separate body from the motor shaft 60. A stepped part 86 is formed on the motor shaft 60. A bottom part 91 of the hypoid pinion 90 makes contact with the stepped part 86 to position the hypoid pinion 90 with respect to the motor shaft 60 in the axial direction. The hypoid pinion 90 has a penetration hole 92 at a central portion in a radial direction thereof, and a tooth flank 93 on an outer periphery thereof. The motor shaft 60 fits into the penetration hole 92. In other words, the position of the tooth flank 93 of the hypoid pinion 90 in the radial direction overlaps the position of the motor shaft 60 in the radial direction, and virtually does not project from a tip end part 61 of the motor shaft 60 in the axial direction towards the reduction gear G2. The hypoid pinion 90 is securely fitted on the motor shaft 60 via the penetration hole 92 and is fixed to the motor shaft 60 by the so-called interference fit, such as press-fit and shrinkage fit. For normal use, such a secure fitting of the hypoid pinion 90 on the motor shaft 60 by the interference fit provides a sufficiently high fixing strength. But in this embodiment, a key 94 is provided to mechanically stop turning of hypoid pinion 90 relative to the motor shaft 60, and in addition, a bolt 98 is screwed into the motor shaft 60 via a set plate 96 as shown in FIG. 2 in order to mechanically stop the hypoid pinion 90 from slipping off the motor shaft 60 in the axial direction. In this embodiment, the method of fixing the hypoid pinion 90 on the motor shaft 60 is not limited to the method described above, and any suitable fixing method may be employed.

The hypoid pinion 90 meshes with a hypoid gear 100 and forms a first gear stage 102. A reduction gear ratio realized by the hypoid pinion 90 and the hypoid gear 100 is 1/3.5, and is set considerably low compared to a reduction gear ratio of 1/5 to 1/15 which is realized by a general hypoid gear set.

The hypoid gear 100 is assembled on a hypoid gear shaft 104. Both ends of the hypoid gear shaft 104 are supported by the reduction gear casing 110 via a ball bearing 106 and a self-centering roller bearing 108, respectively. In addition, a first shim member 112 is arranged adjacent to the ball bearing 106 to form a bearing part, and a second shim member 114 is arranged adjacent to the self-centering roller bearing 108 to form another bearing part. FIG. 4 shows, on an enlarged scale, a state where the second shim member 114 is assembled on an outer side in the axial direction of an outer ring 109 of the self-centering roller bearing 108. Because the second shim member 114 has a thickness of approximately 0.1 mm and is relatively thin, the thickness of the second shim member 114 is exaggerated in FIG. 4. The first shim member 112 on the side of the ball bearing 106 is assembled in a manner similar to the second shim member 114. In FIG. 4, a reference numeral 115 denotes a presser plate which will be described later. The first and second shim members 112 and 114 are separately and respectively arranged adjacent to the ball bearing 106 and the self-centering roller bearing 108. For this reason, an adjustment of the mesh alignment between the hypoid pinion 90 and the hypoid gear 100 and an adjustment of a positional relationship between the hypoid gear shaft 104 and the reduction gear casing 110 can be made independently, thereby enabling optimum settings for the mesh alignment and the positional relationship.

In a case where a relatively low reduction gear ratio is required of the hypoid gear motor HGM2 among the hypoid gear motors of the same series, the reduction gear G2 having the double reduction structure shown in FIG. 2 is employed. The reduction gear G2 has dimensions corresponding to a conventional motor with a frame number of a lower rank in terms of the capacity in the same series of motors. The reduction gear G2 includes an intermediate helical pinion 116 which is assembled on the hypoid gear shaft 104, an output gear 118 which meshes with the intermediate helical pinion 116, and an output shaft 120 which rotates as the output gear 118 rotates.

On the other hand, in a case where a relatively high reduction gear ratio is required of a hypoid gear motor HGM3 among the hypoid gear motors of the same series, a reduction gear G3 having the triple reduction structure shown in FIG. 5 is employed. The reduction gear G3 has the same reduction gear casing 110 as the reduction gear G2. The reduction gear G3 includes an intermediate helical gear 150 which meshes with an intermediate helical pinion 116A, an intermediate shaft 152 having the intermediate helical gear 150 assembled thereon, a second intermediate helical pinion 154 assembled on the intermediate shaft 152, an output gear 118A which meshes with the second intermediate helical pinion 154, and an output shaft 120 which rotates as the output gear 118A rotates. In FIG. 5, a reference numeral 160 denotes a presser plate of a self-centering roller bearing 132.

Both ends of the intermediate shaft 152 of the hypoid gear motor HGM3 are supported by a ball bearing 130 and the self-centering roller bearing 132, respectively. As described above, in FIG. 5, which is a development of the shafts arranged three-dimensionally in the direction perpendicular to the drawing paper, the intermediate shaft 152 appears adjacent to the hypoid gear shaft 104, but actually, a large portion of the intermediate shaft 152 overlaps the hypoid gear shaft 104 in the up and down directions on the drawing paper. The reduction gear casing 110 can be used in common for both the hypoid gear motor HGM2 and the hypoid gear motor HGM3.

In the embodiment described above, one of the bearings 106 and 108 supporting the hypoid gear shaft 104 of the hypoid gear motor HGM2, namely, the bearing 108, is a self-centering roller bearing. The self-centering roller bearing 108 is used in order to positively receive a radial load applied on the hypoid gear shaft 104 via the intermediate helical pinion 116 (or 116A) on the hypoid gear shaft 104, and to also satisfactorily receive a thrust load applied on the hypoid gear shaft 104. For similar reasons, one of the bearings 130 and 132 supporting the intermediate shaft 152 of the hypoid gear motor HGM3, namely, the bearing 132, is a self-centering roller bearing. Of course, both the bearings 106 and 108 or, both the bearings 130 and 132, may be self-centering roller bearings.

Next, a description will be given of a method of producing the hypoid gear motor HGM2 or HGM3, and an operation of the hypoid gear motor HGM2 or HGM3.

When producing the hypoid gear motor HGM2 or HGM3, the key 94 is provided on the motor shaft 60 of the motor M2. Thereafter, the hypoid pinion 90 having the penetration hole 92 is press-fit on the motor shaft 60 so that the motor shaft 60 is fitted into the penetration hole 92, and the hypoid pinion 90 and the motor shaft 60 are fixed more securely by the key 94 and the bolt 98. The hypoid gear shaft 104 having the hypoid gear 100 is assembled into the hypoid gear motor HGM2 or HGM3 while adjusting meshing positions of the hypoid gear 100 and the hypoid pinion 90 to optimum positions using the first shim member 112 which is arranged adjacent to the ball bearing 106 supporting one end of the hypoid gear shaft 104. Then, relative positions of the hypoid gear shaft 104 and the gear casing 100 are adjusted in the axial direction using the second shim member 114 which is arranged adjacent to the self-centering roller bearing 108 supporting the other end of the hypoid gear shaft 104.

Due to the characteristics of the self-centering roller bearing 108, the outer ring 109 of the self-centering roller bearing 108 is easily inclined with respect to an inner ring 111 of the self-centering roller bearing 108. For this reason, it is difficult to assemble the hypoid gear shaft 104, which is supported on the self-centering roller bearing 108, onto the reduction gear casing 110. Hence, in order to prevent the outer ring 109 of the self-centering roller bearing 108 from becoming greatly inclined during the assembling process, a presser plate 115 is inserted between the self-centering roller bearing 108 and the hypoid gear shaft 104. This presser plate 115 is designed so that the presser plate 115 will not simultaneously make contact with both the outer ring 109 and the inner ring 111 of the self-centering roller bearing 108. When assembling the self-centering roller bearing 108, the presser plate 115 and the second shim member 114 are used so that a smooth meshing is achieved between the hypoid pinion 90 and the hypoid gear 100 (or hypoid gear shaft 104).

When the motor shaft 60 of the motor M2 of the hypoid gear motor HHM2 or HGM3 which is produced in this manner rotates, this rotation is transmitted to the hypoid pinion 90 by a frictional stress between the motor shaft 60 and the hypoid pinion 90 and the shear stress of the key 94. When the hypoid pinion 90 rotates, the hypoid gear 100 which meshes with the hypoid pinion 90 rotates. As a result, the intermediate helical pinion 116 (or 116A) is rotated via the hypoid gear shaft 104.

In the case of the hypoid gear motor HGM2 shown in FIG. 2 having the double reduction structure, the power is transmitted from the intermediate helical pinion 116 to the output shaft 120 via the output gear 118. On the other hand, in the case of the hypoid gear motor HGM3 shown in FIG. 5 having the triple reduction structure, the power is transmitted from the intermediate helical pinion 116A to the intermediate helical gear 150, and is transmitted to the output shaft 120 via the intermediate shaft 152, the second intermediate helical pinion 154 and the output gear 118A.

According to the hypoid gear motor HGM2 or HGM3 of the embodiment described above, it is possible to realize various kinds of reduction gear ratios by appropriately modifying the number of teeth of each pinion or gear, while using the same hypoid pinion 90 and the same hypoid gear 100, and further using the same output shaft 120, the same reduction gear casing 110 and the like. In addition, because the reduction gear ratio of the hypoid pinion 90 and the hypoid gear 100 is 1/3.5 which is extremely low, the reduction gear ratio with respect to the hypoid gear 100 having the same outer diameter (or the same transmission torque) become smaller, to thereby enable connection to a larger motor (or motor having a higher capacity). Consequently, it is possible to realize a high capacity while maintaining the size of the reduction gear G2 small.

The hypoid pinion 90 is press-fit on the outer periphery of the motor shaft 60 via the penetration hole 92, and the position of the tooth flank 93 of the hypoid pinion 90 in the axial direction thereof overlaps the position of the motor shaft 60 in the axial direction thereof. Therefore, although the motor shaft 60 and the hypoid pinion 90 are separate bodies, it is possible to prevent the dimensions of the hypoid gear motor HGM2 or HGM3 from increasing in the axial direction of the motor shaft 60, and to maintain the compact size of the hypoid gear motor HGM2 or HGM3.

The so-called general-purpose motors may be used for the motor M2, including the motor shaft 60, which makes it possible to reduce the cost of the hypoid gear motor HGM2 or HGM3. Since the hypoid pinion 90 is separate from the motor shaft 60, it is possible to use a hard material exclusively for the hypoid pinion 90 or, to carry out a process such as a thermal (or heating) process exclusively for the hypoid pinion 90. Consequently, it is possible to improve the basic performance of the hypoid pinion 90, as a power transmission element, at a relatively low cost. Furthermore, because it is possible to carry out the thermal process only with respect to the hypoid pinion 90, it is possible to prevent deformation of the motor shaft 60 which may otherwise occur if the motor shaft 60 were also subjected to the thermal process. Compared to a case where the motor shaft 60 is deformed and a process is carried out to correct the deformation, it is possible to simplify and shorten the production process of the hypoid gear motor HGM2 or HGM3.

In addition, the meshing alignment between the hypoid pinion 90 and the hypoid gear 100 can be adjusted by an exclusive shim member, such as the first shim member 112, and the reduction gear casing 110 and the hypoid gear shaft 104 which is adjusted to optimum position may be aligned by another exclusive shim member, such as the second shim member 114. For this reason, even if a relatively large thrust load, in any direction, is applied on the hypoid gear shaft 104 via the hypoid gear 100 or the intermediate helical pinion 116 (or 116A), it is possible to always maintain an optimum meshing alignment without having to employ a complex structure.

Moreover, if necessary, it is possible to cope with a case where a plurality of kinds of hypoid pinions having slightly different number of teeth exist, by the independent position adjusting functions provided by adjusting the thickness of the presser plate 115 and the first and second shim members 112 and 114. In such a case, it is possible to easily realize a large number of finely controlled reduction gear ratios.

According to the hypoid gear motor HGM2 or HGM3 of the embodiment described above, it is possible to connect to the motor M2 having a large size (or high capacity) using the reduction gear G2 having the dimensions corresponding to a conventional motor with a frame number of a lower rank in terms of the capacity in the same series of motors or, using the reduction gear G3, while maintaining the compact size of the hypoid gear motor HGM2 or HGM3. On the other hand, when viewed from the motor M2 having the high capacity, it is possible to reduce the size of the large reduction gear casing connected to a conventional motor with a frame number of a higher rank in terms of the capacity in the same series of motors to the smaller size of the reduction gear casing 110.

Therefore, the embodiment described above is suited to realizing hypoid gear motors having a high-capacity and realizing a low reduction gear ratio or a high-speed drive, while maintaining the size of the hypoid gear motor relatively compact.

This application claims the benefit of a Japanese Patent Application No. 2007-120143 filed Apr. 27, 2007, in the Japanese Patent Office, the disclosure of which is hereby incorporated by reference.

Further, the present invention is not limited to these embodiments, but various variations and modifications may be made without departing from the scope of the present invention.

What is claimed is:

1. A hypoid gear motor comprising:
a gear casing;
a first bearing;
a second bearing;
a motor having a motor shaft;
a hypoid pinion having a penetration hole, and a tooth flank on an outer periphery thereof, said hypoid pinion being separate from the motor shaft and being fixed to the motor shaft which is fitted into the penetration hole;
a hypoid gear shaft having a hypoid gear which meshes with the hypoid pinion, and two ends respectively supported on the gear casing via the first and second bearings;
a first shim member arranged adjacent to the first bearing; and
a second shim member arranged adjacent to the second bearing,
wherein the first and second shim members independently adjust a position of the hypoid gear shaft in an axial direction thereof with respect to the hypoid pinion and the gear casing.

2. The hypoid gear motor as claimed in claim 1, further comprising:
a motor casing having a cover part; and
a third bearing and a fourth bearing configured to support the motor shaft,
wherein said third bearing is disposed closer to the hypoid pinion than the fourth bearing, and is restricted from movement in an axial direction thereof by the cover part and a first ring body which is fixed on the cover part via a bolt.

3. The hypoid gear motor as claimed in claim 2, wherein the motor shaft has a stepped part, and the hypoid pinion is restricted from movement in an axial direction thereof by the stepped part.

4. The hypoid gear motor as claimed in claim 2, wherein the third bearing has an outer ring which is restricted from movement in an axial direction by a first stepped part which is formed on the cover part and a second stepped part which is formed on the first ring body.

5. The hypoid gear motor as claimed in claim 2, wherein the third bearing has an inner ring which is restricted from movement in an axial direction thereof by the motor shaft and a second ring body which is fitted on the motor shaft.

6. The hypoid gear motor as claimed in claim 1, wherein at least one of the first and second bearings comprises a self-centering roller bearing.

7. The hypoid gear motor as claimed in claim 6, wherein:
the self-centering roller bearing has an outer ring;
and further comprising:
a presser plate configured to prevent inclination of the outer ring.

8. A hypoid gear motor comprising:
a gear casing;
a first bearing part;
a second bearing part;
a motor having a motor shaft;
a hypoid pinion having a penetration hole, and a tooth flank on an outer periphery thereof, said hypoid pinion being fixed to the motor shaft which is fitted into the penetration hole;
a hypoid gear shaft having a hypoid gear which meshes with the hypoid pinion, and two ends respectively supported on the gear casing via the first and second bearing parts,
wherein a position of the hypoid gear shaft in an axial direction thereof with respect to the hypoid pinion and the gear casing is independently adjustable by the first and second bearing parts.

9. A method of producing a hypoid gear motor, comprising the steps of:
(a) fixing a motor shaft of a motor to a hypoid pinion by fitting the motor shaft into a penetration hole in the hypoid pinion;
(b) assembling a hypoid gear shaft having a hypoid gear into the hypoid gear motor while adjusting meshing positions of the hypoid gear and the hypoid pinion using a first shim member which is arranged adjacent to a first bearing supporting one end of the hypoid gear shaft; and
(c) adjusting relative positions of the hypoid gear shaft and a gear casing in an axial direction using a second shim member which is arranged adjacent to a second bearing supporting another end of the hypoid gear shaft.

10. The method of producing the hypoid gear motor as claimed in claim 9, wherein one of the first and second bearings comprises a self-centering roller bearing.

11. The method of producing the hypoid gear motor as claimed in claim 10, further comprising:
(d) inserting a presser plate between the self-centering roller bearing and the hypoid gear shaft to prevent inclination of the self-centering roller bearing.

12. The method of producing the hypoid gear motor as claimed in claim 10, further comprising:
(d) inserting a presser plate between the self-centering roller bearing and the hypoid gear shaft to prevent inclination of an outer ring of the self-centering roller bearing with respect to an inner ring of the self-centering roller bearing.
